(19) United States
(12) Patent Application Publication
(10) Pub. No.: US 2005/0181114 A1
(43) Pub. Date: Aug. 18, 2005

(54) Instant modified flour

(76) Inventor: Thomas Bruemmer, ST. GALLEN (CH)

Correspondence Address: JORDAN AND HAMBURG LLP, 122 EAST 42ND STREET, SUITE 4000, NEW YORK, NY, 10168, US

(21) Appl. No.: 10/509,817

(22) PCT Filed: Feb. 17, 2003
(86) PCT No.: PCT/CH03/00111

(51) Int. Cl. A23G 3/00

(52) U.S. Cl. 426/658

(57) ABSTRACT

A method for producing modified flour or modified powdery to granular, especially fine-grained starch-containing products made of a ground or comminuted raw product containing predominantly starch, such as starch or flour from cereals or tubers, especially wheat, rye flour, cornflour, potato flour, tapioca flour, etc. Also disclosed is a system for carrying out said method. Agglomerates obtained by extrusion and agglomeration have a lower agglomeration level than the individual non-agglomerated particles when dissolved/suspended in water.

The invention relates to a method for producing modified flours or modified powdery to grainy, especially finely grained, starch-containing products from a ground or comminuted raw material product, predominantly containing starch, such as starch or flours from grains or tubers, especially wheat, rye flour, corn flour, potato flour, tapioca flour, etc. in accordance with the introductory portion of claim 1, as well as to a plant of the introductory portion of claim 26 for carrying out the method.

The raw material product is treated by:
a) mixing and wetting the at least one comminuted, starch-containing raw material product with water and/or water vapor and optionally further additives by moving the raw material product in a mixing chamber of a preconditioner during a first residence time for mixing,
b) allowing the water and/or the water vapor to act on the at least one raw material product by moving the raw material product in an action chamber of the preconditioner during a first residence time for action,
c) extruding the mixture of water and raw material product, preconditioned in the mixing chamber and the action chamber in the steps a) and b), the temperature, the pressure, the water content, the mechanical energy introduced and the residence time of the mixture in the extruder being adjusted so that the raw material product is plasticized and/or gelatinized at least partially to a conveyable mixture, containing a modified starch, and
d) palletizing the conveyable mixture and dry grinding the pellets to a predominantly powdery to grainy intermediate product, containing modified starch.

When such powdery to grainy, starch-containing products are dissolved or suspended by stirring in a liquid such as water, milk or oil, they tend to form lumps of varying sizes, which can frequently be dissolved only with difficulty by further mechanical action or after the liquid has acted on the lumps for a long time. There is a great tendency to form lumps especially when the powdery product is brought together with water. For example, on the one hand, suspensions of low viscosity are formed and contain lumps, which accumulate at the bottom of the vessel containing the suspension and/or at the surface of the suspension. On the other, when strongly swelling products are stirred into a liquid, such as water or milk, a relatively homogeneous, more or less viscous paste is formed, in which the lumps may be distributed over the whole volume of the paste. These types of lump formation, encountered while consuming foods in such a dissolved, suspended or pasty, swollen state, tend to be rejected by most consumers.

Every effort is therefore made to ensure that the products, especially powdery products, which are to be dissolved, suspended or brought into a swollen, pasty state, are treated in such a manner that, upon contact with the liquid, all powdery to grainy particles are wetted immediately, to a large extent, that is, practically around their whole surface, in order to prevent any type of clumping. However, when the particles are very small, the liquid, because of its surface tension, is unable to wet all around those particles, which lie in contact with one another. To provide a remedy here, the individual particles are assembled, pursuant to the invention, into agglomerates of a plurality of individual particles, which touch one another only at points and adhere to one another at the contact sites. The adhesion of the particles to one another can be brought about, for example, with the help of a binder and/or by making the particle surfaces tacky. The agglomerates, so produced, must be large enough so that the liquid can penetrate into the interstices between adjacent agglomerates in the liquid in spite of the surface tension of the latter and, accordingly, all agglomerates can immediately be wetted completely (instanticizing). Any formation of lumps is thus prevented and the particles, after the bonds are broken, can go into solution or suspension completely.

Previously known methods for agglomerating or instanticizing powdery or finely particulate products have found use, for example, in the production of agglomerated, powdered coffee, powdered milk or infant food powders.

For the method, disclosed in DE 2161448 A1, powdered coffee or milk, obtained by spray drying, is wetted by steam and then dropped onto a rotating disk, due to the rotation of which the powder is flung beyond the edge of the disk and then falls downward. The wetted powder, falling down, falls through a chamber in which particles of the powder, which have not agglomerated, are deposited, whereas the agglomerated particles of the powder are dried additionally and collected.

The method, disclosed in DE 2005305 Al produces instant coffee from a powder of ground coffee extract. The agglomeration is accomplished here owing to the fact that the powder is introduced from above into a vertical agglomeration chamber, into which steam is passed countercurrently.

These methods have only a relatively low product throughput and require large chambers for the spray drying or the countercurrent wetting with steam. Since the residence time of the powdered particles in the equipment can be adjusted only within the relatively narrow limits, these methods are less suitable especially for the agglomeration/instanticizing of predominantly starch-containing powders.

It is therefore an object of the invention to make available a method for producing agglomerated flours, especially from raw materials products with a high starch content, which enables certain parameters, which determine the extent of the agglomeration, to be adjusted flexibly.

This objective is accomplished by the characterizing distinguishing features of claim 1 and of claim 26 with regard to the method and the equipment respectively.

In this connection, the powdery to grainy intermediate product, obtained in steps a), b), c) and d) by preconditioning, extruding, palletizing and grinding in the dry state, is processed further by
e) mixing and wetting the powdery to grainy intermediate product, obtained in step d), with a fluid as well as optionally other additives by moving the intermediate product in a mixing chamber of an agglomerator during a second mixing residence time for mixing and
f) letting the fluid act on the powdery to grainy intermediate product by moving the intermediate product in an action chamber of the agglomerator during a second residence time for action, so that agglomerates are formed from the particles of the intermediate product, containing the modified starch.

The inventive method enables the residence time of the intermediate product to be adjusted within wide limits specifically for the product in the mixing chamber as well as in the action chamber of the agglomerator. In addition, it enables the product throughput to be increased in comparison to the methods of the state of the art named above.

In the case of an advantageous embodiment of the inventive method, on the one hand, the preconditioner, in which steps a) and b) are carried out, and, on the other, the agglomerator, in which steps e) and f) are carried out, each have a mixing chamber above an action chamber, which are connected with one another, each chamber having a rotor shaft, which extends along the respective chamber and is provided with tools around the shaft. In contrast to the methods of the state of the art, mentioned above, the transport and the residence time of the product in the agglomerator can be adjusted largely independently of the constant gravity. A large spectrum of agglomerates, different, for example, with respect to their average size or their strength and their coherence, can therefore be produced from one and the same raw material product.

In the case of a particularly advantageous embodiment, the preconditioner, used for steps a) and b), and the agglomerator, used for steps e) and f), have the same construction. Accordingly, a large portion of the method can be carried out in parts of the installation, which are identical to one another. As a result, the maintenance of the installation as a whole is simplified. In this way, on the one hand, the preconditioning with the steps a) and b) and, on the other, the agglomeration with the steps e) and f) can be carried out in an identical but not the same machine. The essential difference between preconditioning and agglomerating lies especially therein that, in each case, a different starting material is supplied to the same machine, namely the raw material or the intermediate product.

For the starch-containing raw materials, the residence time of the product in the mixing chamber during step e) advisably is about 0.2 to 5 seconds and preferably 0.3 to 2 seconds and the residence time of the product in the action chamber during step f) advisably is about 10 seconds to 15 minutes and preferably 15 seconds to 60 seconds, the mixing chamber being filled especially to the extent of 1% to 5% and the action chamber being filled to about 25% to 75%.

Advisably, the mixing chamber and the action chamber are at atmospheric pressure and the temperature in the chambers is between ambient and about 98° C.

A fluid or a combination of several fluids, such as water, water vapor, sugar solutions and edible oils, can be metered in for wetting the powdery to grainy product. For this purpose, the fluid preferably is atomized.

Advisably, the agglomerates, obtained in step f), are classified according to their size. The classification preferably takes place in a sifter.

In the case of a particularly advantageous embodiment, the fraction of the agglomerates, which exceeds a specified agglomerate size, is supplied initially to a comminuting device, such as an impact mill, and subsequently, optionally together with the product obtained in step d), once again to the agglomerator and/or the fraction of the agglomerates, which does not attain a specified minimum agglomerate size, optionally together with the product obtained in step d), once again is supplied to the agglomerator. Preferably, the fraction of agglomerates, which do not attain the maximum agglomerate size and/or exceed the minimum agglomerate size, is collected as end product.

Preferably, the method is carried at continuously during and between steps a) to f), further additives, such as flavors, spices, coloring materials, emulsifiers, acids and the like being metered in particularly during at least one of the steps a) to f).

In the case of a further, particularly advantageous embodiment, the intermediate product is moved in the mixing chamber and/or in the action chamber in each case by means of a shaft, which rotates about its longitudinal axis and has radially protruding conveying elements, the shaft of the mixing chamber preferably being driven at a rate of 50 rpm to 900 rpm and especially at a rate of about 700 rpm and the shaft of the action chamber being driven at a rate of about 5 rpm to 30 rpm. Due to the high rotational speed and the peripheral speed of the shaft and because of the low degree, to which the mixing chamber is filled, the intermediate product is fluidized in the mixing chamber and mixed with the fluids that are to be added and wetted uniformly by these. The intermediate product, wetted uniformly in this manner, then reaches the action chamber, which is filled to a much greater extent than is the mixing chamber and the shaft of which is operated at a lower rotational speed than is the shaft of the mixing chamber. The surface of the particles of the starch-containing intermediate product is then wetted, for example, by water and/or water vapor, so that the particles then tend to adhere. This tendency to adhere is counteracted by the movement of the shaft in the action chamber, so that equilibrium comes about between agglomeration of the particles and disintegration of the agglomerates into particles. Agglomerates of different average sizes can be produced by adjusting the amount of fluids added, the rotational speed of the respective shaft in the mixing chamber and in the action chamber, the geometry of the conveying elements, the temperature in the chambers and the thereby specified residence times. In conjunction with the classification, for example, with the help of sifters, described above and renewed, optionally repeated supplying to the agglomerator, practically the whole of the raw material product can be converted into a uniform fraction of agglomerates with a particular average size and in an optionally narrow range of agglomerates sizes.

Advantageously, the mixing chamber and/or the action chamber in each case have essentially the shape of a horizontal cylinder, the axis of rotation of the respective shaft extending along the axis of the cylinder. By these means, the effect of gravity on the degree, to which the chambers is filled with product, which affects the uniform distribution and processing of the product, is largely avoided.

Advantageously, the capacity of the action chamber is about 1.5 times to 10 times and especially about 2to 5 times that of the mixing chamber. By these means and together with the different rotational speeds, the residence time ranges of the product in the mixing chamber and in the action chamber, given above, can be achieved particularly easily.

For most of the starch-containing products, the fluid, used in step e) for wetting the raw material product and in step f) for acting on the raw material product, contain at least water vapor and/or water. The taste of the fluids is largely neutral. In addition, because it has a high heat capacity, wets the surfaces of the product and penetrates into the interior of the product, water is particularly suitable as a heat carrier or a heat transfer agent.

The modified flour, which is obtained pursuant to the invention and consists of agglomerates and is produced from a ground or comminuted raw material product, predominantly containing starch, such as starch or flours from grains or tubers, especially wheat, rye flour, corn flour, potato flour, tapioca flour, etc. or their mixtures and the like according to the method described, consists preferably of agglomerates, the sizes of which range from about 200 μm to about 5 mm and especially from 500 μm to 2 mm.

Further advantages, distinguishing features and possible applications of the invention arise out of the following description of a preferred example of the invention, which is not to be regarded as limiting, by means of the drawings.

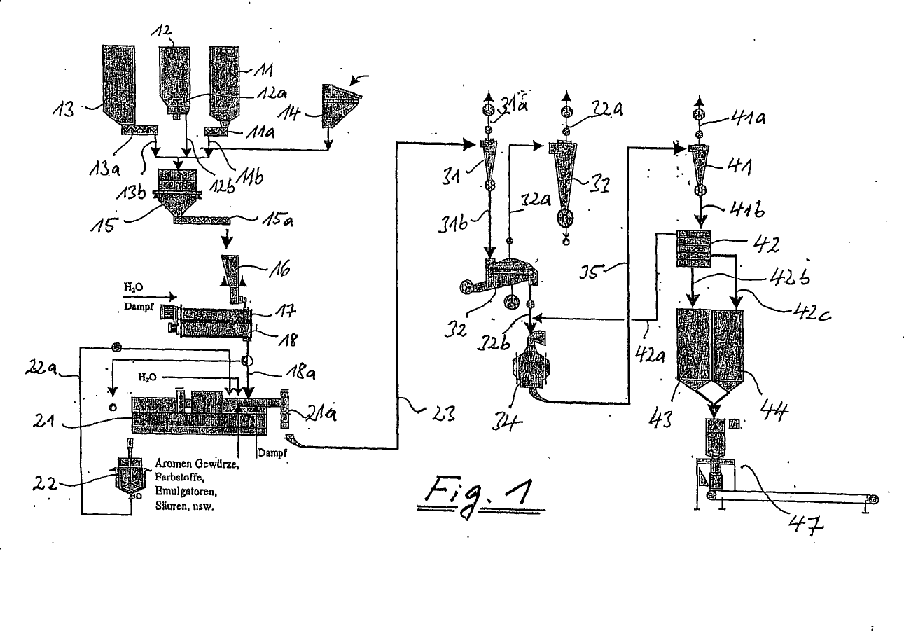

FIG. 1 shows an installation for producing modified flours and starches without special parts of the installation for agglomerating the particles obtained from modified flour or modified starch,

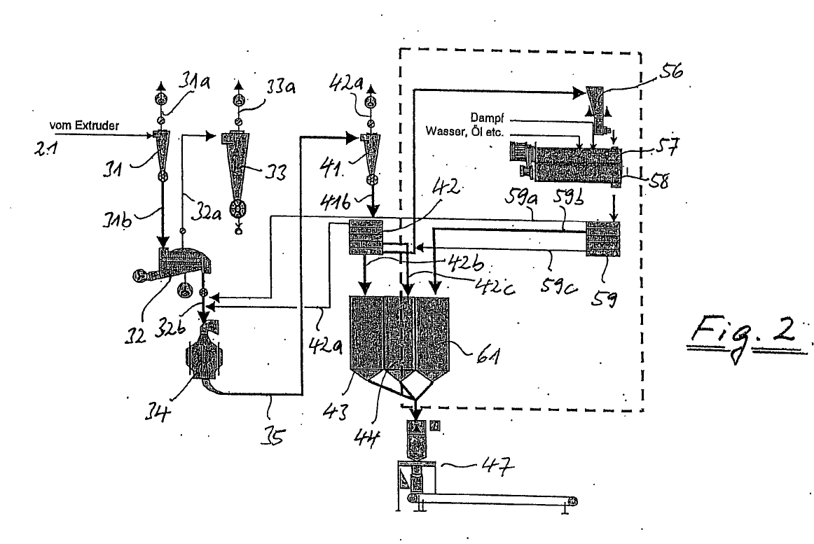

FIG. 2 shows a part of the installation of FIG. 1 in which an inventive part of the installation for agglomerating the particles obtained from modified flour or modified starch into agglomerates is provided,

FIG. 3A shows a first example of an agglomerated, modified flour,

FIG. 3B shows a second example of an agglomerated flour,

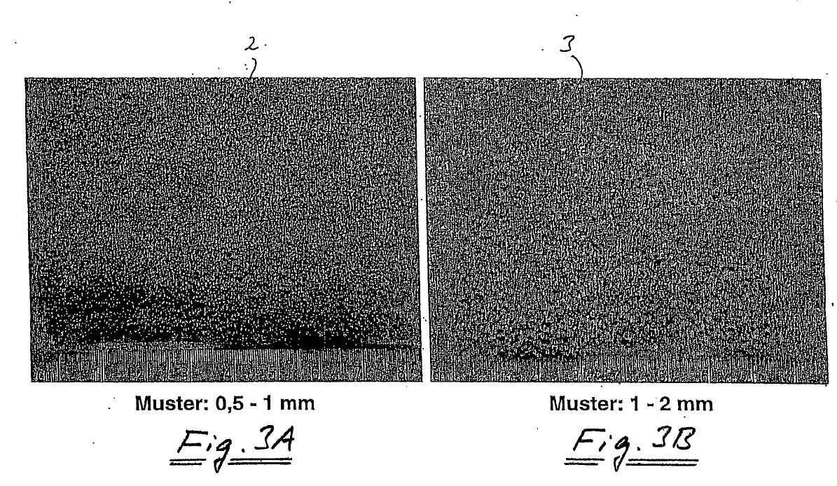

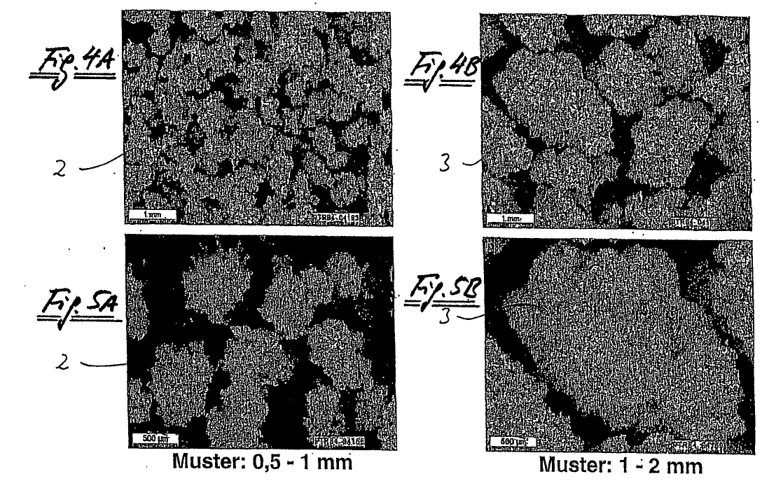

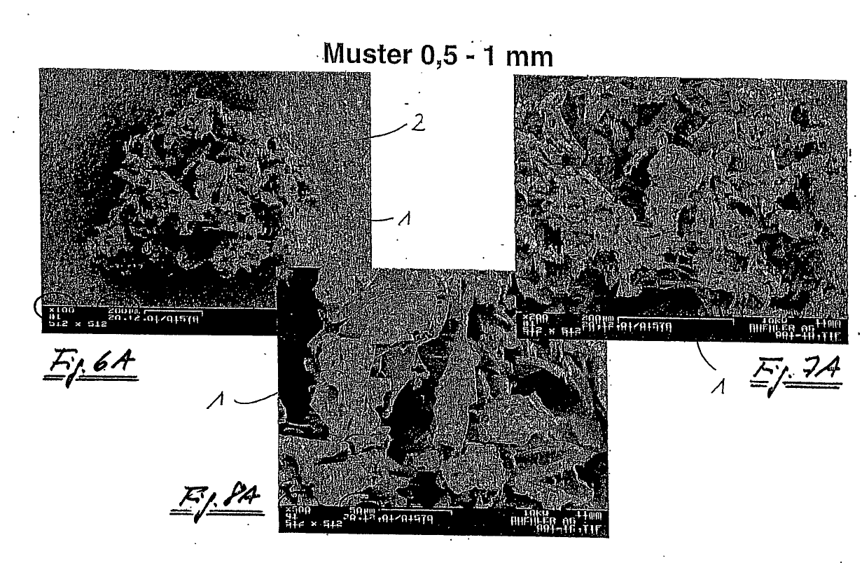

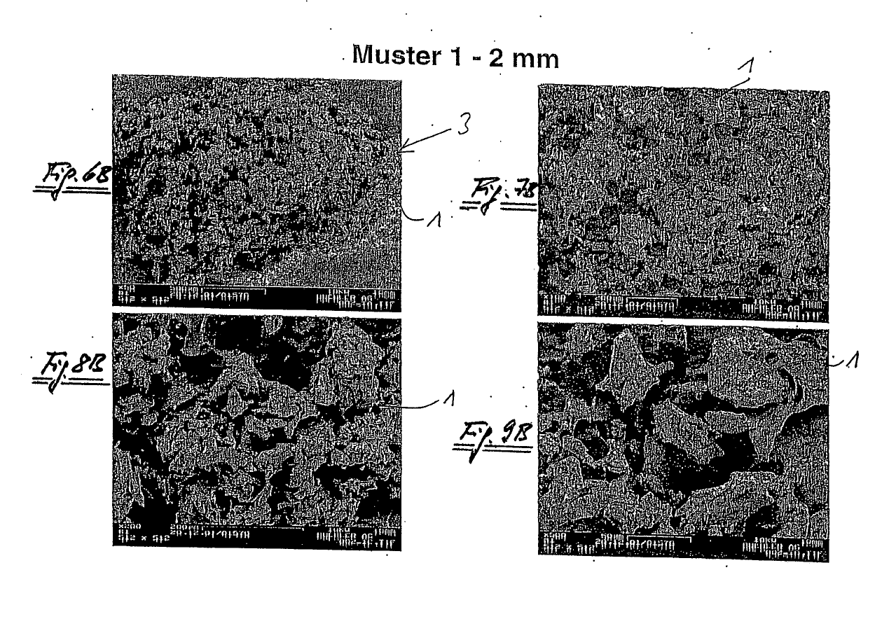

FIGS. 4A to 8B shows the agglomerated, modified flour of FIG. 3A on an increasingly enlarged scale, and

FIGS. 4B to 9B showing the agglomerated, modified flour of FIG. 3B on an increasingly enlarged scale.

FIG. 1 shows an installation for producing modified flours and starches, which consist of individual particles of modified starch. The reservoirs 11 and 13 each have a discharging screw 11a or 13a and are used for preparing and metering solid raw material products, especially in the form of flours. In addition, a sack-emptying device is provided over which additives, such as spices, which are delivered in sacks, can be metered into the raw material product. The reservoir 12 has a stop valve 12a and serves as a container for liquid raw material products, for example. The solid, starch-containing raw materials can be supplied over discharging screws 11a and 13a and the respective pipelines 11b or 13b to a mixing and metering device 15. The liquid raw materials of the reservoir 12 can be supplied to the mixing and metering device 15 over the raw material pipeline 12d. The mixing and metering device 15 has a discharging screw 15a, in which the raw material product mixture is discharged and transferred to a metering funnel 16 downstream from the mixing and metering device 15. The raw material mixture, which may also already contain, if required, a liquid metered in from the reservoir 12 in addition to the solid, starch-containing raw materials, then reaches the mixing chamber 17 of a preconditioner directly and subsequently an action chamber 18 of this preconditioner. A shaft, which is provided with tools (not shown), extends in the cylindrical mixing chamber 17 as well as in the cylindrical action chamber 18 of the preconditioner. Water vapor and optionally water and/or other liquids are added in the mixing chamber 17 to the raw material product, consisting of various raw materials, while the shaft is rotating in the mixing chamber 17. The rotation of the shaft in the mixing chamber produces a fluidization of the powdery to grainy raw material product and a uniform wetting by the condensing water vapor of the liquids added. After the raw material product has been wetted completely in the mixing chamber 17, it reaches the action chamber 18 of the preconditioner. The shaft, rotating in the action chamber 18, incorporates water, wetting the raw material product, as well as any other liquid admixtures. The capacity of the action chamber 18 is greater than that of the mixing chamber 17 and the rotation of the shaft of the action chamber 18 is much slower than that of the mixing chamber 17. As a result, the residence time of the raw material product in the mixing chamber 17 is shorter than that in the action chamber 18 and the degree of filling is less. The raw material product passes through the mixing chamber 17 from the right to the left and then reaches the action chamber 18, in which it is conveyed from the left to the right. Finally, it reaches an extruder 21 by way of a pipeline 18a. The actual modification of the starch-containing raw material product takes place in the extruder 21. The starch-containing raw material product, which is present, for example, in the form of a flour and/or a gritty material, is plasticized and/or turned into a paste by thermal, mechanical and possibly also chemical actions of the water contained in the raw material product, the original structure of the starch in the raw material product being destroyed. The starch-containing raw material product, so modified, can be shaped into pellets at the outlet of the extruder by means of a pelletizing device 21a. In addition to water vapor, other materials, such as flavors, spices, coloring materials, emulsifiers, acids and the like are admixed with the raw material product in the extruder 21, in order to modify the chemical and physical properties of the product. These other materials admixed are prepared in a separate mixing container and metered into the extruder over a pipeline 22a.

The pellets, so obtained, which consist predominantly of modified or thermoplastic starch, are transported over a transporting pipeline 23, for example, pneumatically to a cyclone. Here the pellets are separated from the surrounding moist, hot air, which is separated over a suction pipeline 31a with an exhaust fan from the solid material discharged from the rotary vane lock of a pipeline 31b. The solid portion or pellets reach a dryer 32 by way of the pipeline 31b. A fluidized bed dryer or a belt dryer, for example, can be used as dryer. In much the same way as in the case of the cyclone, further hot moist air is drawn off over an exhaust pipeline 32a and reaches a cyclone 33, in which the exhausted, moist air is separated from the fines portion contained in it. Essentially, a two-step drying takes place. The first drying step consists of separating the hot moist air in the cyclone 31 at the end of the pneumatic pipeline 23, while the second drying step takes place in the dryer 32. The pellets, so dried, pass from the dryer 32 over a pipeline 32b into the mill 34 for the dry milling. A hammer mill or a roller mill, for example, may be used for the dry milling of the pellets. From the mill 34, the milled material, which now represents modified starch or flour, is transported pneumatically, for example, over a further transporting pipeline 35 into a cyclone 41. In this cyclone 41, air is also separated from the solid particles. The air is exhausted with an exhaust fan in exhaust pipeline 41a, while the solids portion passes through a pipeline 41b with a rotary vane lock into a sifter 42.

The product, so produced from the various raw materials, is referred to in the following as modified flour.

The modified flour is classified into different fractions in the sifter 42. The coarse portion is returned by way of pipeline 42a into pipeline 32b, in order to be milled once again in the mill together with the pellets. A first fraction and a second fraction of the modified flour leave the sifter 42 by way of pipelines 42b and 42c and reach the reservoirs 43 and 44. The modified flour is stored here as a dry product. Adjoining the reservoirs 43 and 44 for the first and second fractions of the modified flour, there is a mixing and packaging device, in which a modified flour or a starch, consisting of a mixture of the first and second fractions in a particular ratio, is packaged in specified amounts.

FIG. 2 shows an inventive expansion of the installation of FIG. 1, in which an inventive part of the installation for agglomerating the particles obtained from modified flours into agglomerates is provided. The additional part of the installation contains an agglomerator as a further significant element, which has a mixing chamber 57 and an action chamber 58. This agglomerator may have the same construction as the preconditioner (see FIG. 1), the mixing chambers 17 and 57 and the action chambers 18 and 58 corresponding to one another. In this agglomerator, agglomeration of the particles into modified flour takes place. The fine portion from the sifter 42 is used for the agglomeration. This fine portion, when brought together with water, tends to result in the lumping described above, which makes it difficult to form a homogeneous suspension of the particles of the modified flour or to dissolve the particles in water. Over a transporting pipeline 42d and a metering device 56, which corresponds to the metering funnel 16 (see FIG. 1) of the preconditioner, this fine portion of the modified flour or of the modified scratch reaches the mixing chamber 57 of the agglomerator. In the mixing chamber 57, the starch particles of the modified flour are treated with steam, water, oil and the like, which leads to the wetting of the intermediate product in the mixing chamber 57.

In much the same way as in the preconditioning (see FIG. 1), an intensive uniform wetting takes place here also. From the mixing chamber 57, the wetted intermediate product reaches the action chamber 58 of the agglomerator, in which the liquids, especially water, wetting the intermediate product, penetrate gradually into the intermediate product. The mixing chamber 57, as well as the action chamber 58 of the agglomerator also each contain a rotor shaft, at which tools are mounted. However, an action of or penetration by the liquid is not necessary. In order to achieve an agglomeration of the particles of the modified flour, forming the intermediate product, the shaft in the mixing chamber 57 is operated at a speed of 500 rpm to 900 rpm and especially of about 700 rpm, as a result of which the modified flour is fluidized and wetted very rapidly and uniformly with water, steam, oil etc. After a relatively short residence time of the intermediate product in the mixing chamber 57 of about 0.2 to 4 seconds and preferably of about 0.3 to 2 seconds, the wetted intermediate product reaches the action chamber 58, the shaft of which is operated at a much lower speed of about 5 rpm to 30 rpm. Because of the greater capacity of the action chamber 58 and the much lower rotational speed of the shaft in the action chamber 58, the residence times of the intermediate product are about 10 seconds to 15 minutes; preferably, however, they range from 15 seconds to 60 seconds. The mixing chamber is filled to the extent of 1% to 5%. On the other hand, the action chamber is filled to the extent of about 25% to 75%. During the whole of the agglomeration, the temperature in the mixing chamber 57 and the action chamber 58 of the agglomerator is kept between ambient temperature and a little below 100° C., if the work is carried out at atmospheric pressure

The agglomerated, modified flour or the agglomerated modified starch, so obtained, leaves the agglomerator and is supplied to a sifter 59. As in the sifter 42, in which the modified flour, which has not yet been agglomerated, is divided into a coarse fraction in pipeline 42a as well as into a first fraction in pipeline 42b and a second fraction in pipeline 42c, the modified flour, agglomerated in the agglomerator, is divided into several fractions. The coarse portion is returned over pipeline 59a into pipeline 32d and, together with the newly supplied starch pellets, is milled in the mill 34. As already described in FIG. 1, this coarse portion then once again reaches the cyclone 41 by way of pipeline 35 and, from there, the sifter 42 and, from there, either the reservoir 43 or 44 or, by way of pipeline 42d, the agglomerator once again. The product fraction, the size of the agglomerates of which falls within an acceptable range, leaves the sifter 59 by way of pipeline 59b and reaches the reservoir 61 for the product fraction of agglomerated, modified flour. The fine portion, which consists predominantly of starch particles, which have not been agglomerated, or of agglomerates that are too small, is supplied by the sifter 59 over pipeline 59c to the pipeline 42d, by way of which it also is returned once again to the agglomerator. Finally, the whole of the fine portion of the starch particles of the modified flour, which has not been agglomerated, as well as the agglomerated, modified flour is processed into sufficiently large agglomerates. Accordingly, the interfering fine portion is prevented, on the one hand, from being present in the exhaust air and, on the other, from being present in the modified flour products or the modified starch products. As described in FIG. 1, in the final analysis, quite special product mixtures can also be produced in the inventive installation and by the inventive method in the mixing and packaging device 47. For example, a product mixture can be prepared, which consists only of modified flour that has not been agglomerated and in which the product of the reservoir 43 and/or of the reservoir 44 are used. Of course, product packages can also be produced, which contain only agglomerated, modified flour, in that one resorts only to reservoir 61. Mixtures of modified flour, which has and which has not been agglomerated, are also possible by combining the contents of reservoirs 43, 44 and 61.

Since one and the same type of machine or one and the same type of installation part surprisingly can be used for the preconditioning the raw material product from the reservoir before the extrusion as well as for agglomerating the intermediate product obtained from the extruder, the inventive agglomerates can be produced from modified flour particles or modified starch particles particularly economically by means of the inventive installation of FIG. 2. The same holds good also for the sifter.

FIG. 3A shows, as a first example of an agglomerated, modified flour, agglomerated, swellable rye flour with an average agglomerate particle size ranging from 0.5 to 1 mm. FIG. 3B shows, as a second example of an agglomerator flour, an agglomerated swellable, rye flour with an average agglomerate particle size ranging from 1 to 2 mm.

The same modified flour was used as starting material for the agglomerated, swellable rye flour with the smaller agglomerates as well as for the agglomerated swellable rye flour with the larger agglomerates. The average size of the agglomerates obtained can be varied by adjusting the rpm of the shaft in the mixing chamber 57 and of the shaft in the action chamber 58, as well as by the amount of intermediate product supplied and also by the amount of steam, water, oil etc. fed in per unit time. Within the scope of the spectrum of agglomerate sizes so obtained in the agglomerator, special fractions, such as the somewhat finer fraction of FIG. 3A and the somewhat coarser fraction of FIG. 3B, can then be isolated by sifting.

FIGS. 4A to 8A show the somewhat finer fraction of the agglomerated, swellable rye flour with agglomerate particle sizes ranging from 0.5 to 1 mm with increasing magnification. Similarly, FIGS. 4B to 9B show the somewhat coarser fraction of the agglomerated, swellable rye flour with agglomerate particle sizes ranging from 1 to 2 mm with increasing magnification.

The agglomerates of the fraction of the agglomerated rye flour, ranging in size from 0.5 to 1 mm, are labeled 2, whereas the agglomerates of the agglomerated, swellable rye flour, ranging in size from 1 to 2 mm, are labeled 3. The exact, magnified structure of the agglomerates obtained can be seen in the electron microscopic enlargements of FIGS. 6A, 7A, 8A as well as of FIGS. 6B, 7B, 8B and 9B. In particular, it can be seen that the respective agglomerates 2 or 3 consist of many individual particles 1 of modified rye flour, which are glued to one another at only a few parts of their surfaces. The particles 1, so glued to one another, in each case form a relatively open structure in agglomerates 2 and 3. A distinguishing feature of this structure consists therein that the agglomerates are about 500 μm to 2 mm in size whereas the size of the individual particles 1 of modified starch ranges from 10 to 100 μm and, in particular, from about 20 to 60 μm. Accordingly, the ratio of the average size of particles 1 to that of agglomerates 2 or 3 ranges from about 1:20 to about 1:5. Upon contact with water or other solvents, the swellable rye flour (instanticized swellable rye flour), agglomerated pursuant to the invention, shows a much lower tendency to adhere or to form lumps than do the particles 1 of modified starch, which have not been agglomerated and form the basis for the agglomerates 2 and 3.

### REFERENCE NUMBERS

1 particles (starch particles, of which the modified flour comprises)
2 agglomerates (comprising many particles) of a first fraction
3 agglomerates (comprising many particles) of a second fraction
11 reservoir for flours and other raw material products
12 reservoir for flours and other raw material products
13 reservoir for flours and other raw material products
14 sack-emptying device for additives
15 mixing and metering device for starch-containing raw materials
16 metering funnel
17 mixing chamber of the preconditioner
18 action chamber of the precondition or
21 extruder
22 mixing container for materials admixed
23 transporting pipeline for pellets of modified starch
31 cyclone
32 fluidized bed dryer/belt dryer
33 cyclone
34 mill for dry milling
35 transporting pipeline for modified flour
41 cyclone
42 sifter
42a pipeline for coarse portion
42b pipeline for first product fraction
42c pipeline for second product fraction
43 reservoir for first fraction of modified flour
44 reservoir for second fraction of modified flour
47 mixing and packaging device for modified flour
42d pipeline for fine portion of modified flour
56 metering device for intermediate product
57 mixing chamber for the agglomerator
58 action chamber for the agglomerator
59 sifter
59a pipeline for coarse portion of the agglomerates
59b pipeline for product fraction of agglomerated modified flour
59c fine portion of the agglomerates
61 reservoir for product fraction of agglomerated modified flour
31a exhaust pipeline with fan
33 exhaust pipeline with fan
41a exhaust pipeline with fan
31d pipeline for solids with rotary vane lock
33d pipeline for solids with rotary vane lock
41d pipeline for solids with rotary vane lock

1. Method for producing modified flours or modified powdery to grainy, especially finely grained, starch-containing products from a ground or comminuted raw material product, predominantly containing starch, the method comprising the following steps:
a) mixing and wetting the at least one comminuted, starch-containing raw material product with water and/or water vapor and optionally further additives by moving the raw material product in a mixing chamber of a preconditioner during a first residence time for mixing,
b) allowing the water and/or the water vapor to act on the at least one raw material product by moving the raw material product in an action chamber of the preconditioner during a first residence time for action,
c) extruding the mixture of water and raw material product, preconditioned in the mixing chamber and the action chamber in steps a) and b), the temperature, the pressure, the water content, the mechanical energy introduced and the residence time of the mixture in the extruder being adjusted so that an at least partial plasticization and/or gelatinization of the raw material product to a conveyable mixture, containing a modified starch, takes place and
d) pelletizing the conveyable mixture and dry grinding the pellets to a predominantly powdery to grainy intermediate product, containing modified starch,
wherein the powdery to grainy intermediate product, obtained by palletizing in step d), is agglomerated by:
e) mixing and wetting the powdery to grainy intermediate product, obtained in step d), with a fluid as well as optionally other additives by moving the intermediate product in a mixing chamber of an agglomerator during a second mixing residence time for mixing, and
f) allowing the fluid to act on the powdery to grainy intermediate product by moving the intermediate product in an action chamber of the agglomerator during a second residence time for action, so that agglomerates are formed from the particles of the intermediate, containing the modified starch.

2. The method of claim 1, wherein the preconditioner, in which steps a) and b) are carried outs, and the agglomerator, in which steps e) and f) are carried out, each have a mixing chamber above an action chamber, which are connected with one another, each chamber having a rotor shaft, which extends along the respective chamber and is provided all around with tools.

3. The method of, claim 1, wherein the preconditioner and the agglomerator have the same construction.

4. The method of claim 1, wherein the residence time of the product in the mixing chamber during step e) is about 0.2 to 5 seconds.

5. The method of one of claim 1, wherein the residence time of the product in the action chamber during step f) is about 10 seconds to 15 minutes.

6. The method of claim 1, wherein the mixing chamber is filled to the extent of about 1 to 5%.

7. The method of claim 1, wherein the action chamber is filled to the extent of about 25 to 75%.

8. The method of that claim 4, wherein the pressure in the mixing chamber and the action chamber is atmospheric pressure and the temperature of the chambers in each case is between ambient temperature and about 98° C.

9. The method of claim 1, wherein a combination of several fluids, which are contained in the group comprising water, water vapor, sugar solutions and edible oil, is or will be metered in to wet the powdery to grainy product.

10. The method of claim 9, wherein the fluid or fluids is/are or will be atomized when metered in.

11. The method of claim 1, wherein the agglomerates, obtained in step f), are classified according to size.

12. The method of claim 11, wherein the classification takes place in a sifter.

13. The method of claim 11, wherein the fraction of the agglomerates, which exceed a specified maximum agglomerate size, initially is supplied to a comminuting device, and subsequently, once again is supplied to the agglomerator.

14. The method of claim 11, wherein the fraction of the agglomerates, which are smaller than a specified minimum agglomerate size, once again is supplied to the agglomerator.

15. The method of claim 13, wherein the fraction of the agglomerates, which are smaller than the maximum agglomerates size and/or larger than the minimum agglomerates size, is collected as end product.

16. The method of claim 1, wherein the during and between a) and f) are carried out continuously.

17. The method of claim 1, wherein further additives are metered in during at least one of the steps a) to f).

18. The method of claim 1, wherein the intermediate product in the mixing chamber is moved by means of a shaft, which rotates about its longitudinal axis and has radially protruding conveying elements.

19. The method of claim 1, wherein the intermediate product in the action chamber is moved by means of a shaft, which rotates about its longitudinal axis and has radially protruding conveying elements.

20. The method of claim 18, wherein the shaft of the mixing chamber is driven at a rate of about 50 rpm to 900 rpm.

21. The method of claim 18, wherein the shaft of the action chamber is driven at a rate of about 5 rpm to 30 rpm.

22. The method of claim 18, wherein the mixing chamber essentially has the shape of a horizontal cylinder, the axis of rotation of the shaft extending along the axis of the cylinder.

23. The method of claim 18, wherein the action chamber essentially is in the shape of a horizontal cylinder, the axis of rotation of the shaft extending along the axis of the cylinder.

24. The method of claim 18, wherein the capacity of the action chamber is about 1.5 times to 10 times of the mixing chamber.

25. The method of claim 1, wherein the fluid, used in step e) for wetting the intermediate product and in step f) for acting on the intermediate product, contains at least water vapor and/or water.

26. Installation for producing modified flours or modified, powdery to grainy, especially finally grained, starch-containing products from a ground or comminuted raw material product, predominantly containing starch the installation comprising:
a preconditioner with a mixing chamber for mixing and wetting the at least one comminuted, starch-containing raw material product with water and/or water vapor as well as optionally further additives and an action chamber for permitting the water and/or water vapor to act on the at least one raw material product,
an extruder for extruding the preconditioned mixture, containing water and the raw material product and emerging from the mixing chamber and the action chamber, the extruder having a pelletizing device for pelletizing the mixture emerging from the extruder,
a mill for grinding the pellets dry into a powdery to grainy intermediate products, and
an agglomerator for agglomerating the powdery to grainy intermediate product,
wherein the agglomerator comprises:
a mixing chamber for mixing and wetting the powdery to grainy intermediate product, obtained in the mill, with a fluid, and an action chamber for allowing the fluid to action the powdery to grainy intermediate product.

27. The installation of claim 26, wherein the preconditioner and/or the agglomerator each have a mixing chamber above an action chamber, which are connected with one another, each chamber having a rotor shaft, which extends along the respective chamber and is provided with tools around the shaft.

28. The installation of claim 26, wherein the precondition has the same construction as the agglomerator.

29. The installation of claim 26, wherein the mixing chamber essentially has the shape of a horizontal cylinder, the axis of rotation of the shaft extending along the axis of the cylinder.

30. The installation of claim 26, wherein the action chamber essentially has the shape of a horizontal cylinder, the axis of rotation of the shaft extending along the axis of the cylinder.

31. Modified flour, which comprises agglomerates, which are produced from a ground or comminuted, predominantly starch-containing raw material product, according to the method of claim 1.

32. The modified flour of claim 31, wherein the agglomerates range in size essentially from about 200 μm to 5 mm.

33. The method of claim 1, wherein said ground or comminuted raw material product, predominantly containing starch includes starch or flours from grains or tubers, selected from the group consisting of wheat, rye flour, corn flour, potato flour, tapioca flour, etc. and their mixtures and the like.

34. The method of claim 4, wherein the residence time of the product in the mixing chamber during step e) is about 0.3 to 2 seconds.

35. The method of claim 5, wherein the residence time of the product in the action chamber during step f) is about 15 seconds to 60 seconds.

36. The method of claim 13, wherein said comminuting device comprises an impact mill.

37. The method of claim 11, wherein the fraction of the agglomerates, which exceed a specified maximum agglomerate size, initially is supplied to a comminuting device, and subsequently, together with the product obtained in step d), once again is supplied to the agglomerator.

38. The method of claim 11, wherein the fraction of the agglomerates, which are smaller than a specified minimum agglomerate size, together with the product obtained in step d), once again is supplied to the agglomerator.

39. The method of claim 17, wherein said further additives are selected from the group consisting of flavors, spices, coloring materials, emulsifiers, acids and the like.

40. The method of claim 20, wherein the mixing chamber is driven at a rate of about 700 rpm.

41. The method of claim 24, wherein the capacity of the action chamber is about twice to five times that of the mixing chamber.

42. Installation for producing modified flours or modified, powdery to grainy, especially finally grained, starch-containing products from a ground or comminuted raw material product, predominantly containing starch, using the method of claim 1, the installation having the following parts or machines:
a preconditioner with a mixing chamber for mixing and wetting the at least one comminuted, starch-containing raw material product with water and/or water vapor as well as optionally further additives and an action chamber for permitting the water and/or water vapor to act on the at least one raw material product,
an extruder for extruding the preconditioned mixture, containing water and the raw material product and emerging from the mixing chamber and the action chamber, the extruder having a pelletizing device for pelletizing the mixture emerging from the extruder,
a mill for grinding the pellets dry into a powdery to grainy intermediate product and
an agglomerator for agglomerating the powdery to grainy intermediate product,
wherein the agglomerator comprises:
a mixing chamber for mixing and wetting the powdery to grainy intermediate product, obtained in the mill, with a fluid, and an action chamber for allowing the fluid to action the powdery to grainy intermediate product.

43. The installation of claim 26, wherein the mixing chamber for mixing and wetting the powdery to grainy intermediate product, obtained in the mill, with a fluid also mixes further additives.

44. The modified flour of claim 31, wherein the starch-containing raw material product includes starch or flour from grain or tubers selected from the group consisting of wheat, rye flour, corn flour, potato flour, tapioca flour, etc. and their mixtures and the like.

45. The modified flour of claim 32, wherein the agglomerates range in size essentially from 500 μm to 2 mm.
